(19) United States
(12) Patent Application Publication
(10) Pub. No.: US 2015/0364905 A1
(43) Pub. Date: Dec. 17, 2015

(54) CONDUIT FITTING SPLITTER

(71) Applicant: Ted Russell Fehrman, Caldwell, OH (US)

(72) Inventor: Ted Russell Fehrman, Caldwell, OH (US)

(21) Appl. No.: 14/737,348

(22) Filed: Jun. 11, 2015

Related U.S. Application Data
(60) Provisional application No. 62/010,720, filed on Jun. 11, 2014.

(51) Int. Cl. H02G 1/12; B25B 27/02; H02G 3/06

(52) U.S. Cl. CPC H02G 1/1297; H02G 3/06; B25B 27/02

(57) ABSTRACT

A conduit fitting splitter to facilitate the controlled fracture of a conduit fitting with minimal, or no, deformation or damage to the adjacent conduit, and without damaging the internal wiring. This is accomplished through a plurality of unique relationships that promote the initiation of a plurality of cracks within the conduit fitting and control the propagation of the cracks through the conduit fitting until it fractures into multiple pieces, thereby allowing the reuse of adjacent conduit and the internal wiring.

### CROSS-REFERENCE TO RELATED APPLICATIONS

This application claims the benefit of U.S. provisional patent application Ser. No. 62/010,720, filed on Jun. 11, 2014, all of which are incorporated by reference as if completely written herein.

### STATEMENT REGARDING FEDERALLY SPONSORED RESEARCH OR DEVELOPMENT

Not applicable.

### TECHNICAL FIELD OF THE INVENTION

The present invention relates generally selective demolition equipment, more specifically equipment for the engineered fracture and removal of fittings from a conduit system while minimizing, or eliminating, damage to the conduit and/or its contents.

### BACKGROUND OF THE INVENTION

The present invention generally relates to conduit fitting splitters, and more particularly to hazardous location conduit fitting splitters for facilitating the removal of conduit fittings installed on conduit raceways. Hazardous location conduit fittings are also known as explosion proof fittings are sealing fittings. Hazardous location conduit fittings are required by the National Electrical Code (NEC) in areas classified as hazardous. The National Electrical Code (NEC) Article 500 defines a hazardous location as any area where fire or explosion hazards may exist due to flammable gases, flammable liquid-produced vapors, combustible liquid-produced vapors, combustible dusts, or ignitable fibers/flyings. Examples of these types of applications would include but not limited to: chemical plants; textile plants; grain elevators and mills; and areas where petroleum products are processed, used or stored. In the event of an explosion, burning gases travel through a conduit raceway. During an explosion, gases in front of the burning gases inside of a conduit raceway produces an effect called “piling pressure,” resulting in tremendous explosive pressures and mechanical stress on the conduit raceway. Hazardous location conduit fittings are designed to seal off sections of conduit raceways so that vapors and explosions are prevented from traveling throughout the conduit system. As one can deduce, hazardous location conduit fittings have thicker walls and an overall sturdier structure than ordinary conduit fittings in order to withstand tremendous explosive pressures and mechanical stresses caused by the “piling pressure” effect.

Unfortunately, there are times when modifications or repairs must be made to wiring systems and/or conduit raceways to facilitate equipment upgrades or renovations. In these times, hazardous location conduit fittings must be removed from the conduit. Due to the fact that hazardous location conduit fittings have thick walls and a sturdy structure, the removal process is laborious and dangerous. Grinders or other abrasive cutters may be used to remove hazardous location conduit fittings but require special permits and extreme safety precautions as these methods usually produce sparks. Furthermore, removing hazardous location conduit fittings with grinders or other abrasive cutters often results in ruined conduit and damage to the contents of the conduit.

### SUMMARY OF THE INVENTION

A conduit fitting splitter to facilitate the controlled fracture of a conduit fitting with minimal, or no, deformation or damage to the adjacent conduit, and without damaging the internal wiring. This is accomplished through a plurality of unique relationships that promote the initiation of a plurality of cracks within the conduit fitting and control the propagation of the cracks through the conduit fitting until it fractures into multiple pieces, thereby allowing the reuse of adjacent conduit and the internal wiring.

### BRIEF DESCRIPTION OF THE DRAWINGS

Without limiting the scope of the present conduit fitting splitter as claimed below and referring now to the drawings and figures:

FIG. 1 shows an isometric view of an embodiment of a conduit fitting splitter;

FIG. 2 shows another isometric view of an embodiment of a conduit fitting splitter;

FIG. 3 shows an isometric view of another embodiment of a conduit fitting splitter;

FIG. 4 shows a cross-sectional view of a conduit fitting having: wiring, fiber fill and sealing compound;

FIG. 5 shows top and bottom plan views of an embodiment of conduit fitting splitter proximal and distal jaws;

FIG. 6 shows an embodiment of an exploded side elevation view of a conduit fitting splitter;

FIG. 7 shows an exploded side elevation view of a conduit fitting splitter;

FIG. 8 shows an exploded side elevation view of a conduit fitting splitter;

FIG. 9 shows an exploded side elevation view of a conduit fitting splitter;

FIG. 10 shows a partially assembled side elevation view of a conduit fitting splitter;

FIG. 11 shows a side elevation view of a conduit fitting splitter;

FIG. 12 shows a side elevation view of a another embodiment of a conduit fitting splitter;

FIG. 13 shows a top plan view of an embodiment of a conduit fitting splitter;

FIG. 14 shows a front elevation view of an embodiment of a conduit fitting splitter;

FIG. 15 shows a side elevation view of a another embodiment of a conduit fitting splitter;

FIG. 16 shows a top plan view of an embodiment of a conduit fitting splitter;

FIG. 17 shows a front elevation view of an embodiment of a conduit fitting splitter;

FIG. 18 shows a side elevation view of an embodiment of a conduit fitting splitter and a conduit fitting;

FIG. 19 shows a top plan view of a split conduit fitting;

FIG. 20 shows a side elevation view of another embodiment of a conduit fitting splitter and a conduit fitting;

FIG. 21 shows a front elevation view of another embodiment of a conduit fitting splitter;

FIG. 22 shows a front elevation view of a conduit raceway with conduit fittings;

FIG. 23 shows a top plan view of conduit raceway with conduit fittings;

FIG. 24 shows a front elevation view of a conduit raceway with conduit fittings and an embodiment of the conduit fitting splitter;

FIG. 25 shows a top plan view of conduit raceway with conduit fittings and an embodiment of the conduit fitting splitter;

FIG. 26 shows an isometric view of a hydraulic hand operated conduit fitting splitter;

FIG. 27 shows another isometric view of an embodiment of a conduit fitting splitter;

FIG. 28 shows another isometric view of an embodiment of a conduit fitting splitter;

FIG. 29 shows another isometric view of an embodiment of a conduit fitting splitter;

FIG. 30 shows a front elevation view of a conduit raceway with conduit fittings and an embodiment of the conduit fitting splitter; and

FIG. 31 shows a top plan view of conduit raceway with conduit fittings and an embodiment of the conduit fitting splitter.

These illustrations are provided to assist in the understanding of the exemplary embodiments of a blind fastener as described in more detail below and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The conduit fitting splitter and method enable a significant advance in the state of the art. The preferred embodiments of the conduit fitting splitter and method accomplish this by new and novel designs and steps that are configured in unique and novel ways and which demonstrate previously unavailable but preferred and desirable capabilities. The description set forth below in connection with the drawings is intended merely as a description of the presently preferred embodiments of the conduit fitting splitter and method, and is not intended to represent the only form in which the conduit fitting splitter may be constructed or utilized. The description sets forth the designs, functions, means, and methods of implementing the splitter and method in connection with the illustrated embodiments. It is to be understood, however, that the same or equivalent functions and features may be accomplished by different embodiments that are also intended to be encompassed within the spirit and scope of the conduit fitting splitter and method.

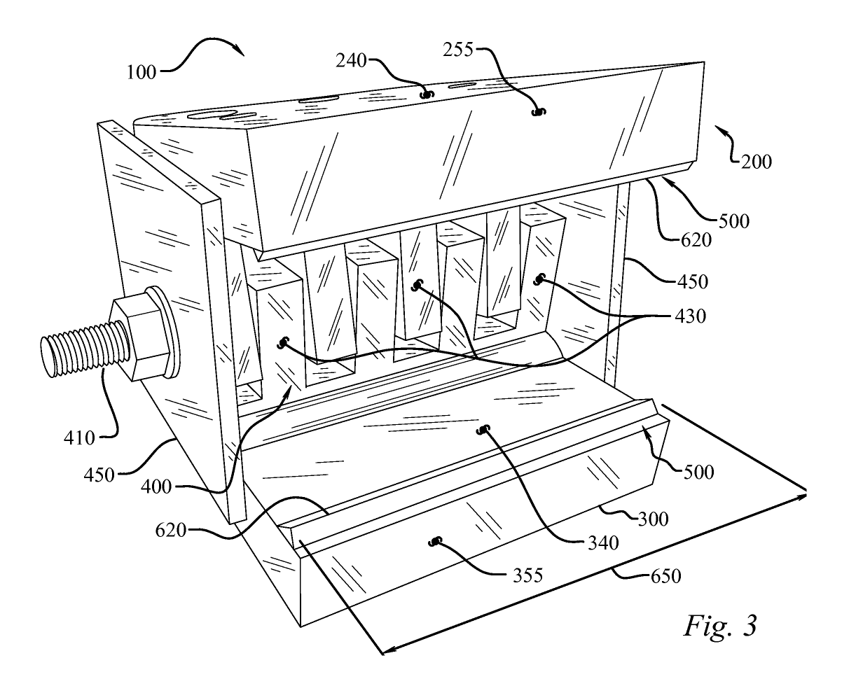

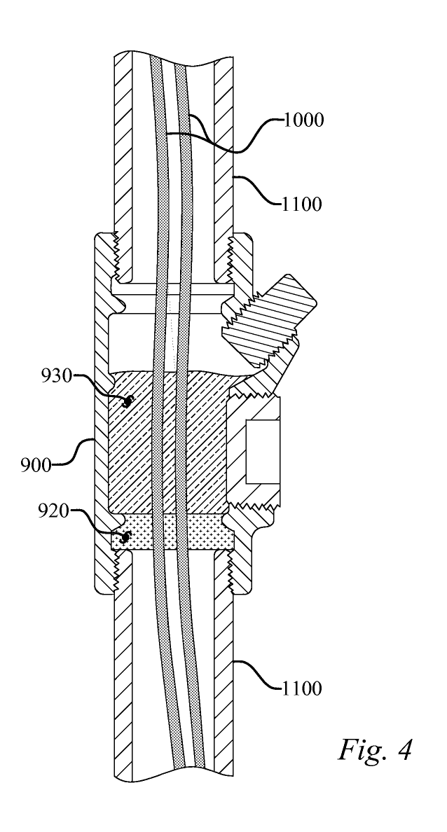

A conduit fitting splitter (100) and method serve to split open previously installed conduit fittings, more specifically explosion proof conduit fittings (100), also known as hazardous location conduit fittings (100), and a controlled and spark-free manner. In operation, the conduit fitting splitter (100) applies pressure on at least one side of a conduit fitting (900) in a precisely engineered and controlled manner to initiate, and promote, crack propagation through the fitting (900) to break it onto multiple large pieces, without causing the potential for sparks and guarding against damage to the conduit (1100), or the wiring (1000) therein. Explosion proof conduit fittings (900) act as a barrier to explosive gases and flames inside conduit raceways. The barrier inside explosion proof conduit fittings (900) normally has two components, namely, a fiber fill (920), or packing, and a sealing compound (930), as seen in FIG. 4. The fiber fill (920) is inserted into the lower section of the conduit fitting (900) which acts as a barrier to the sealing compound (930) that is poured on top of the fiber fill (920); thereby localizing the sealing compound (930) and preventing it from flowing out of the conduit fitting (900). After which, the sealing compound (930) hardens inside the conduit fitting (900) and forms a barrier cable of withstanding any “piling pressure” in the event of an explosion.

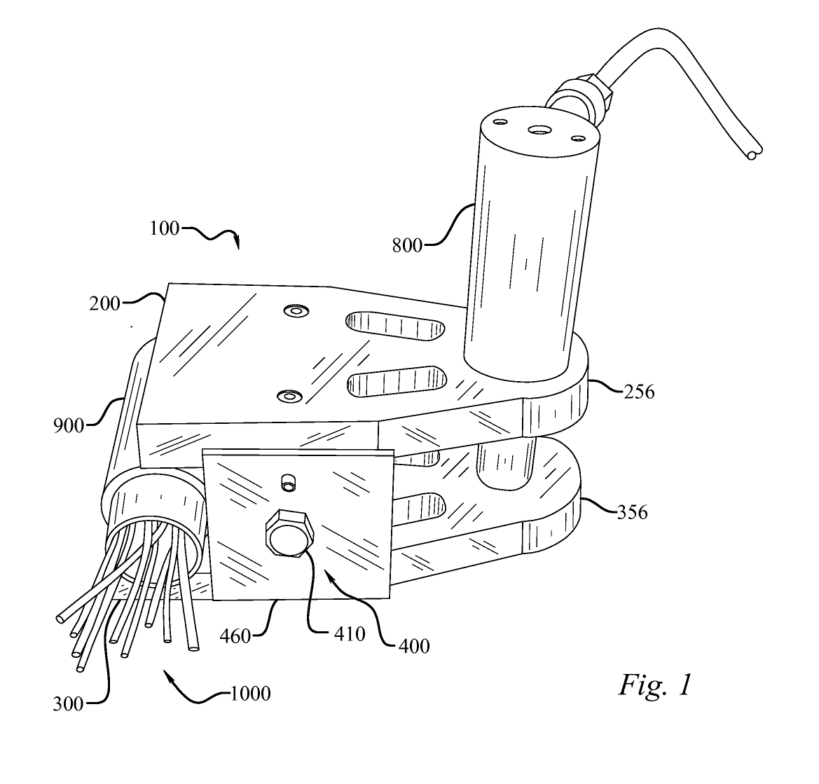

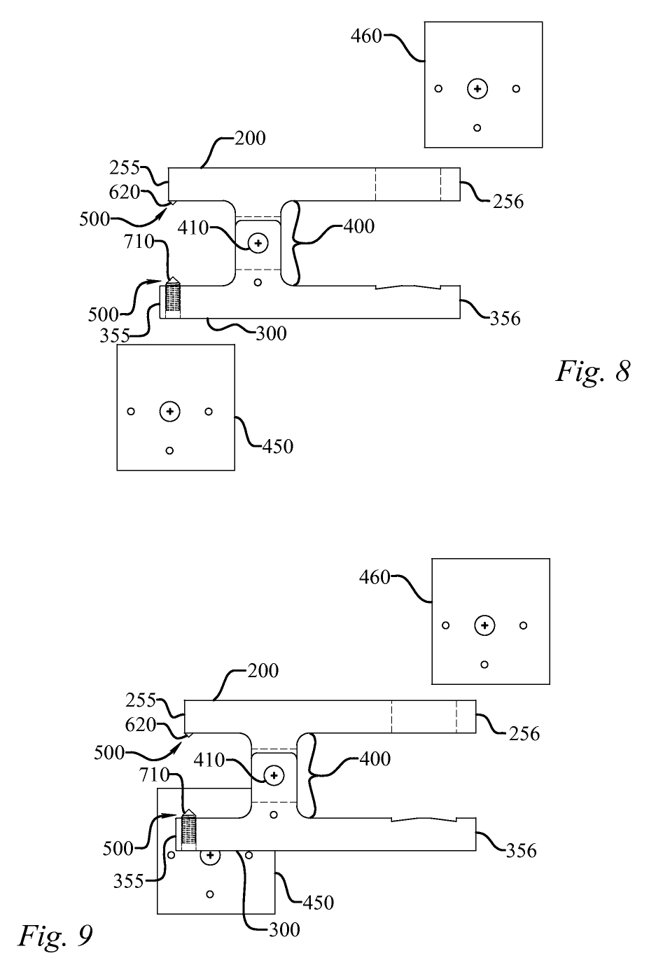

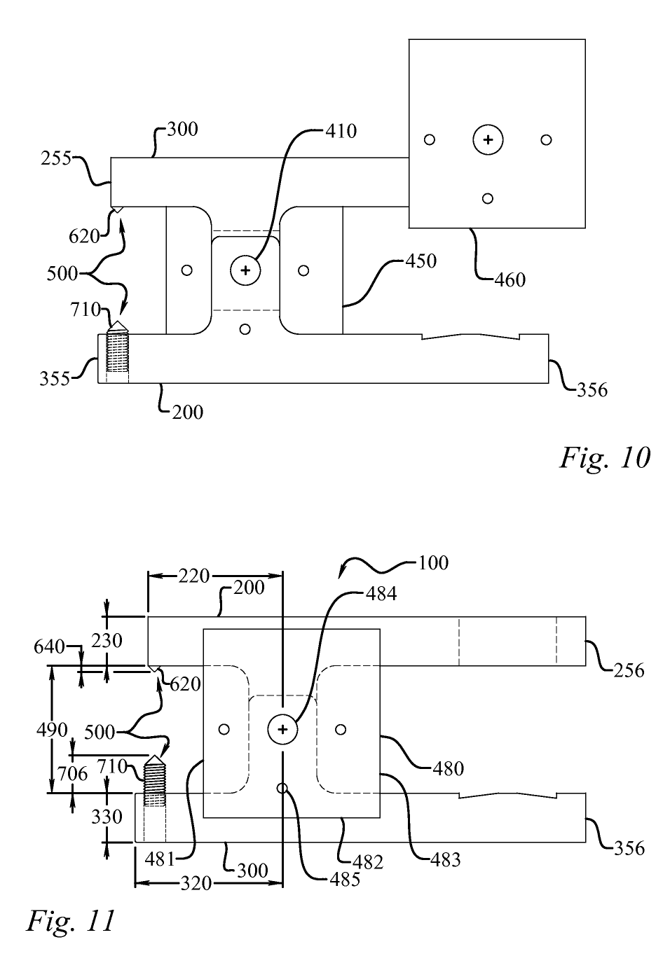

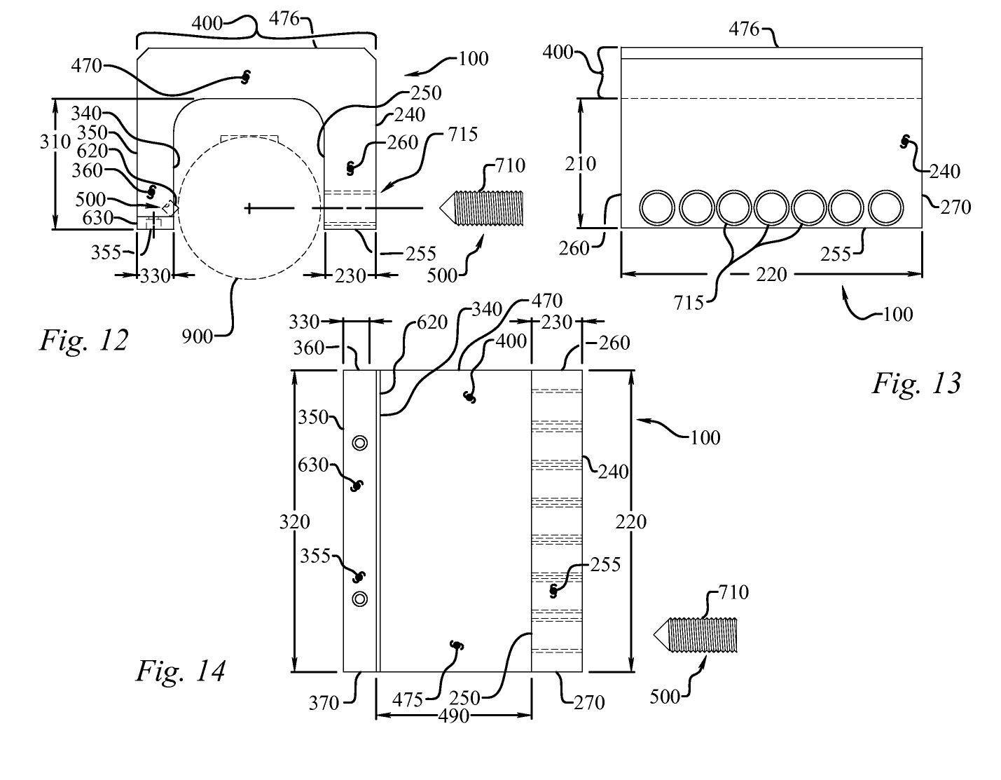

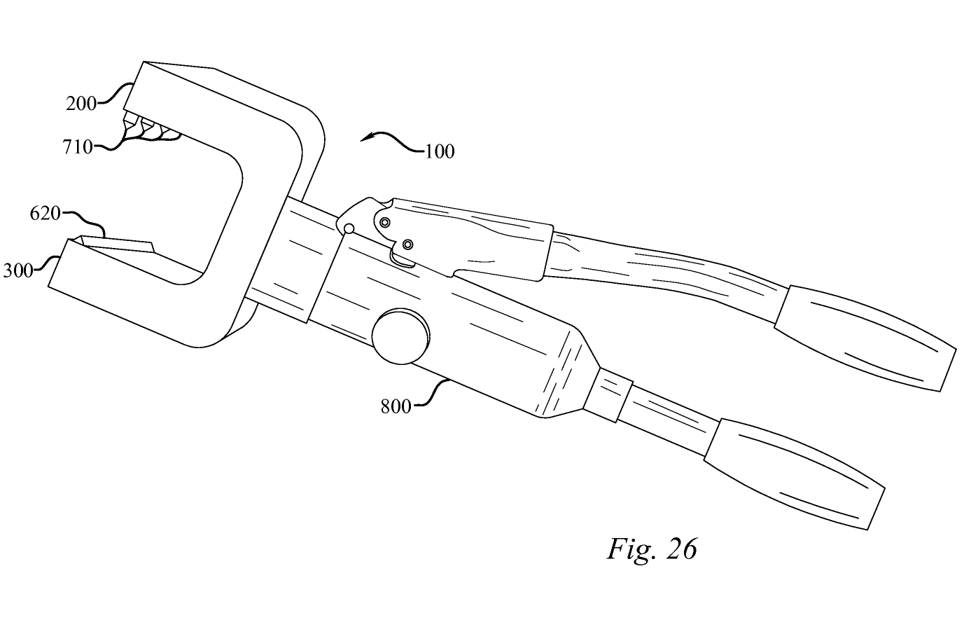

FIGS. 1-31 show embodiments of a conduit fitting splitter (100), including pivoting jaw embodiments seen in FIGS. 1-11 and 27-29, stationary jaw embodiments seen in FIGS. 12-25 and 30-31, and a stationary jaw power assisted embodiment seen in FIG. 26. The pivoting jaw embodiments may include components such as a proximal jaw (200), a distal jaw (300), and a jaw interconnect (400). Likewise, the stationary jaw embodiments seen in FIGS. 12-21 and 30-31 also includes a proximal jaw (200), a distal jaw (300), and a jaw interconnect (400).

The pivoting jaw embodiments may include a pivoting interconnect (410), at least one crack propagating projection (500), and a conduit fitting splitter actuator (800). The pivoting interconnect (410) may include an endplate pivoting system having a sinistral interconnect plate (450) and a dextral interconnect plate (460) and or a pivoting system based upon the use of cooperating proximal jaw fingers (420) and distal jaw fingers (430), held together via a pivot pin. Some embodiments may include a sinistral interconnect plate (450) and/or a dextral interconnect plate (460), either of which may be a fitting positioner (480), as seen in FIG. 11, to control the location of conduit fitting (900) within the conduit fitting splitter (100) to ensure proper placement with respect to the at least one crack propagating projection (500), as will be described in greater detail later.

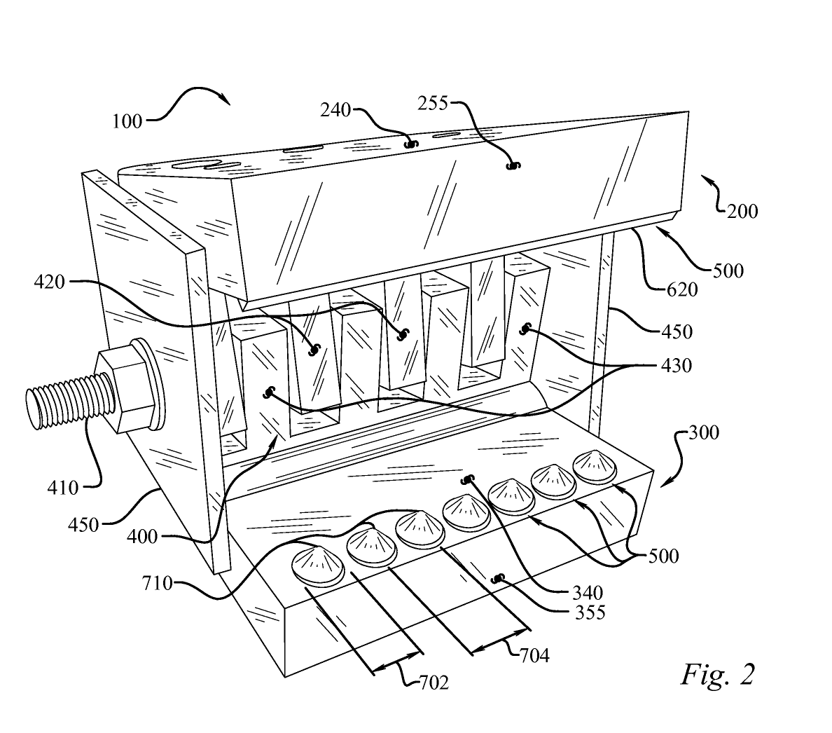

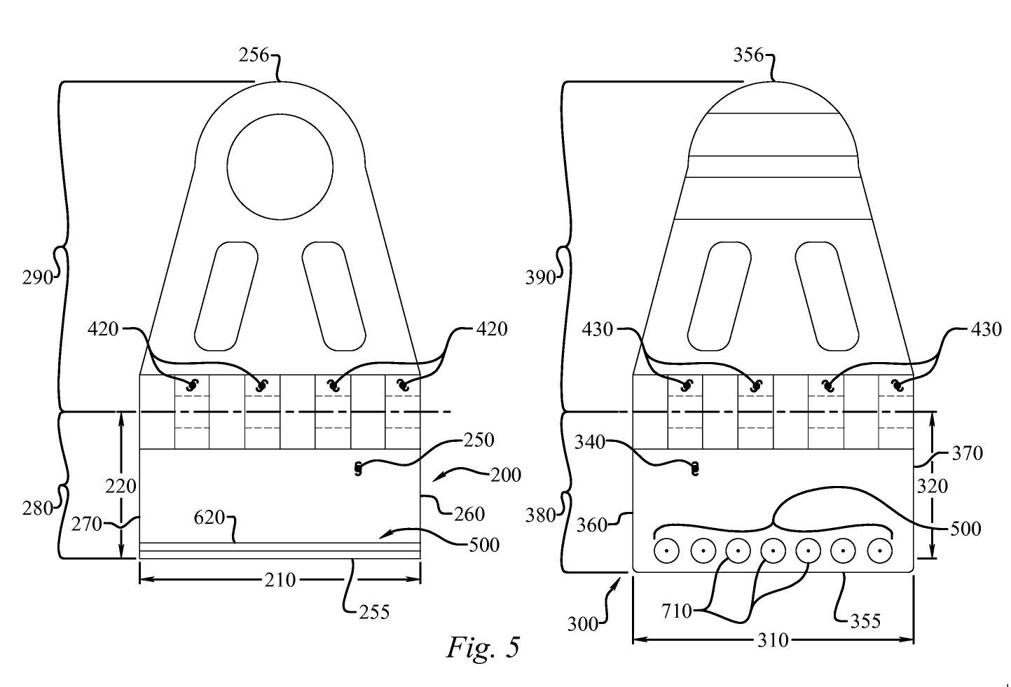

Now with reference to FIGS. 5 and 11, the proximal jaw (200) may have a proximal jaw sinistral side (260), a proximal jaw dextral side (270), a proximal jaw front side (255), a proximal jaw rear side (256), a proximal jaw exterior surface (240), a proximal jaw interior surface (250), a set of proximal jaw fingers (420), a proximal jaw length (210), defined by the distance from the proximal jaw sinistral side (260) to the proximal jaw dextral side (270), a proximal jaw width (220), defined by the distance from the proximal jaw front side (255) to the midpoint of the proximal jaw fingers (420), a proximal jaw height (230), being defined as the distance between the proximal jaw exterior surface (240) and the proximal jaw interior surface (250), and a crack propagation projection (500) located on the proximal jaw interior surface (250) in close proximity to the proximal jaw front side (255), as seen in FIGS. 2, 3, 5, and 6-11. Furthermore, the proximal jaw (200) may have a proximal jaw front region (280) and a proximal jaw rear region (290). The proximal jaw front region (280) being defined as the area located between the proximal jaw fingers (420) and the proximal jaw front side (255). The proximal jaw rear region (290) being defined as the area located between the proximal jaw fingers (420) and the proximal jaw rear side (256).

Similarly, the distal jaw (300) may have a distal jaw sinistral side (360), a distal jaw dextral side (370), a distal jaw front side (355), a distal jaw rear side (356), an distal jaw interior surface (340), a distal jaw exterior surface (350), a set of proximal jaw fingers (430), a distal jaw length (310), defined by the distance from the distal jaw sinistral side (360) to the distal jaw dextral side (370), a distal jaw width (320), defined by the distance from the distal jaw front side (355) to the midpoint of the distal jaw fingers (430), a distal jaw height (330), as defined as the distance between the distal jaw interior surface (340) and distal jaw exterior surface (350), and a crack propagation projection (500) located on the distal jaw interior surface (340) in close proximity to the distal jaw (200) front side (355), as seen in FIGS. 2, 3, 5, and 6-11. The distal jaw (300) may have a distal jaw front region (380) and a distal jaw rear region (390). The distal jaw front region (380) being defined as the area located between the distal jaw fingers (430) and the distal jaw (300) front side (355). The distal jaw rear region (390) is defined as the area located between the distal jaw fingers (430) and the distal jaw rear side (356), as seen in FIG. 5.

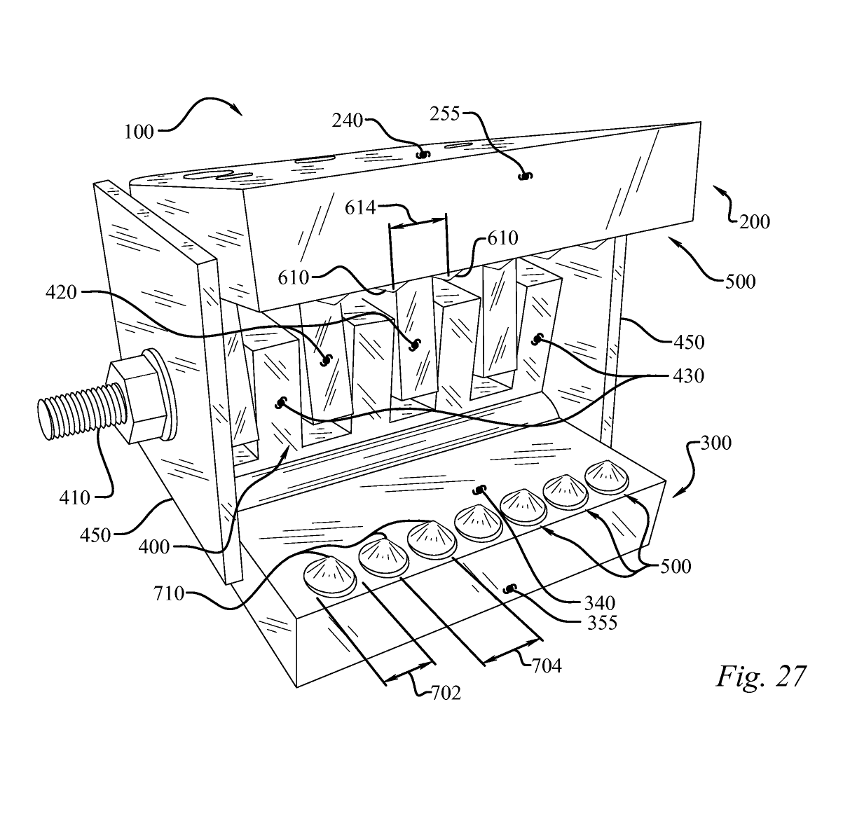

The at least one crack propagation projection (500) may be a fixed point crack propagation projection (610), seen in FIG. 27, or an fixed edge crack propagation projection (620), seen in FIG. 2, that does not move independently of the proximal or distal jaws (200, 300). Alternatively, the at least one crack propagation projection (500) may be an adjustable crack propagation projection (700) that may be an adjustable point crack propagation projection (710) or an adjustable edge crack propagation projection (720) that moves independently of the proximal or distal jaws (200, 300), as seen in FIG. 21. The adjustable crack propagation projection (700) may utilize a mechanical adjuster (730) such as, but not limited to, a threaded adjustable point crack propagation projection (710). Additionally, the adjustable crack propagation projection (700) may utilize a force assisted adjuster (740), such as an adjustable point crack propagation projection (710) or an adjustable edge crack propagation projection (720), seen in FIG. 21, that is adjusted with hydraulic or pneumatic pressure. In an embodiment the at least one adjustable edge crack propagation projection (720) utilizes rotation of a portion of the projection to cause axial movement of the edge projection, without rotation of the edge projection, via a bearing system connecting the edge projection to the rotational body portion, thus a set screw design may also be used with an edge projection. The force assisted adjuster (740) may be hydraulic or pneumatic, manual or powered, and integral with the splitter (100) or a separate system.

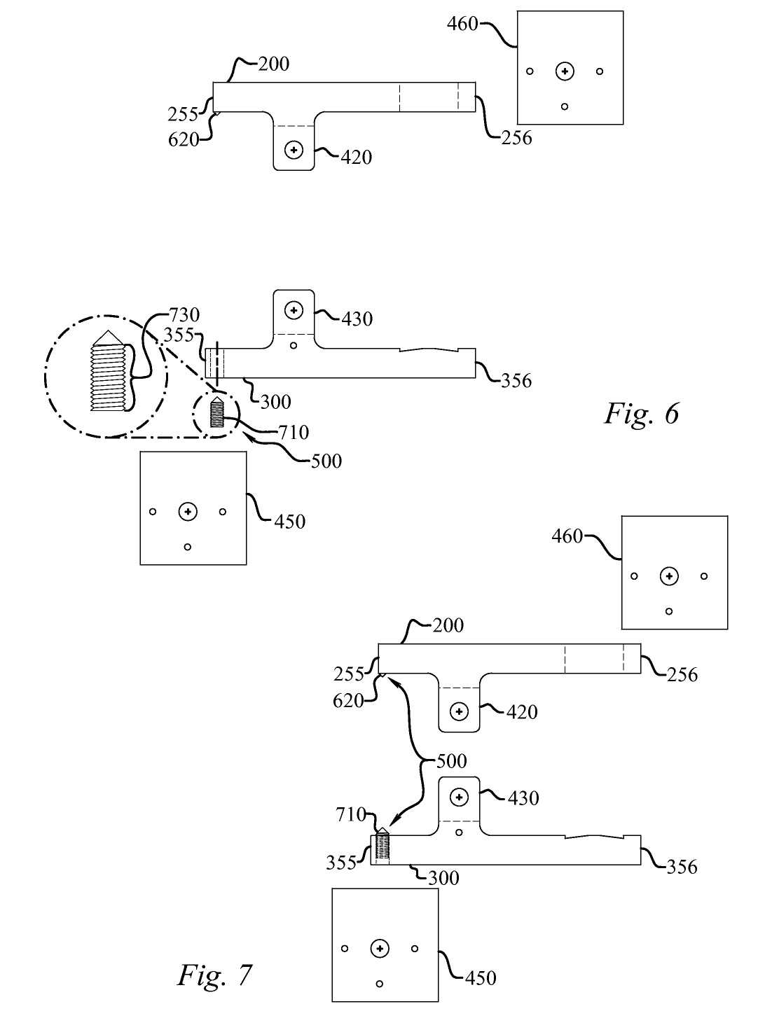

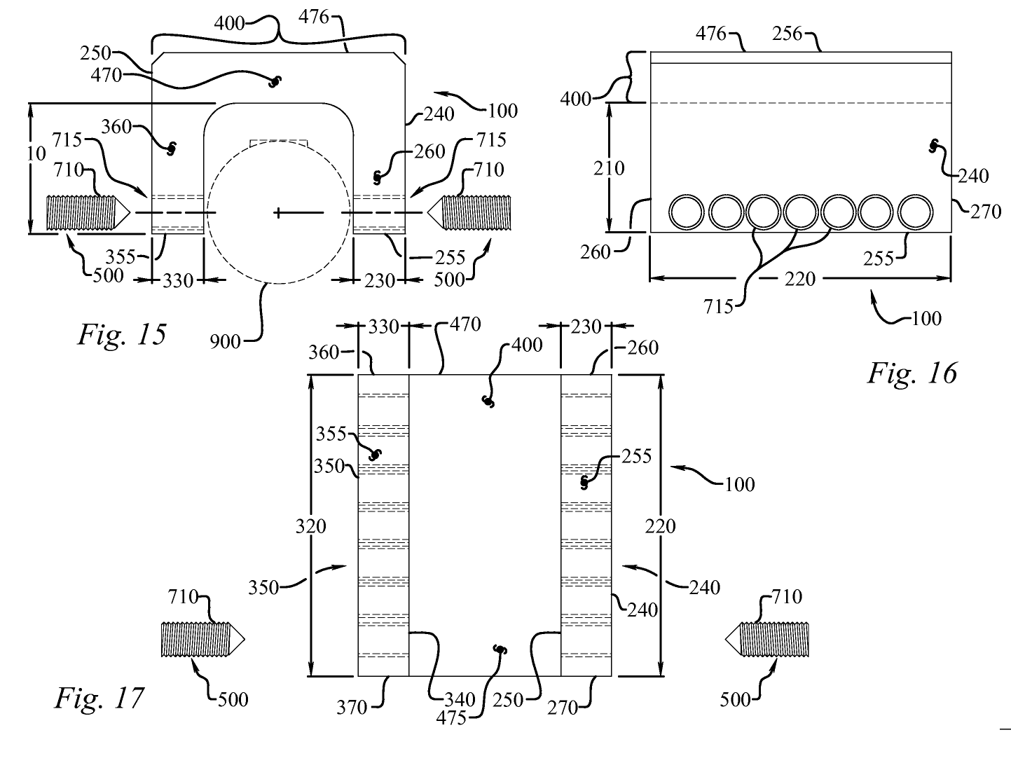

FIGS. 6-11, illustrate the steps of assembling one embodiment of the conduit fitting splitter (100). FIG. 6 is an exploded view of the conduit fitting splitter (100) that illustrates an uninstalled crack propagation projection (500) that is an adjustable point projection (710) having a mechanical adjuster (730) in the form of threads, which engage threads located in an aperture located in the distal jaw (300). It should be noted that multiple adjustable point projections (710) may be used in various embodiments of the conduit fitting splitter (100). For instance, FIG. 2 illustrates multiple adjustable point crack propagation projections (700) located on the distal jaw (300) and a fixed edge crack propagation projection (620) located on the proximal jaw (200). In another embodiment, multiple adjustable point projection crack propagation projections (710) may be located on the proximal jaw (200) and a fixed edge projection crack propagation projection (620) located on the distal jaw (300). In yet another embodiment, both the proximal and distal jaws (200, 300) may utilize various numbers of adjustable point projections (710) and omit a fixed edge projection crack propagation projection (620), for example as seen in FIG. 15, or vice versa as seen in FIG. 3.

Another embodiment may have a fixed edge projection crack propagation projection (620) located both on the proximal and distal jaws (200, 300), as seen in FIG. 3. Now referencing FIG. 7, in this illustration the adjustable point projection (710) crack propagation projection (500) is in an installed state and the proximal and distal jaws (200, 300) are moved into closer proximity to each other. Furthermore, the proximal jaw (200) has proximal jaw fingers (420) and the distal jaw (300) has distal jaw fingers (430) shown in FIGS. 2, 3, 6 and 7. In FIGS. 2, 3 and 8, the proximal and distal jaws (200, 300) are mated together forming a pivoting interconnect (410) jaw interconnect (400) that forms a pivot allowing the proximal jaw (200) to move with respect to the distal jaw (300). The conduit fitting splitter (100) may have a sinistral interconnect plate (450) and/or a dextral interconnect plate (460), as illustrated in FIGS. 2, 3, and 6-10, in lieu of, or in addition to, the jaw fingers (420, 430). In FIGS. 9-11, the sinistral interconnect plate (450) and a dextral interconnect plate (460) are shown moving progressively into the installed position. FIG. 11 shows an embodiment of a fully assembled conduit fitting splitter (100) without an actuator (800). FIG. 1 shows an assembled isometric view of this embodiment of conduit fitting splitter (100) with an actuator (800) installed.

Actuators can take many forms, for instance, but not limited to: hydraulic actuators; pneumatic actuators; mechanical actuators; geared electric motor actuators; or linear electric motor actuators. In the embodiment show in FIG. 1, the actuator (800) is a hydraulic actuator (800) that is attached to the proximal jaw rear region (290). The hydraulic actuator (800) has a piston that exerts force against distal jaw rear region (390); thereby, forcing the proximal jaw rear region (290) and the distal jaw rear region (390) apart. As a consequence, the proximal jaw front region (280) and the distal jaw front region (380) move into closer proximity of one another. When a conduit fitting (900) is placed within the area between the proximal jaw front region (280) and the distal jaw front region (380) and the actuator (800) is activated, the proximal and distal jaws (200, 300) close upon the conduit fitting (900). After which, the force of the jaws are concentrated and applied by the crack propagation projections (500) that are located on the proximal and distal jaws (200, 300) onto the opposite sides of the conduit fitting (900). During this time, the force is increased by the actuator (800) until the conduit fitting (900) fractures and splits into at least two parts in a carefully controlled manner whereby the size, position, and spacing of the crack propagation projections (500) present a unique combination to create and control the propagation of cracks within the conduit fitting (900) to reduce, or eliminate, damage to the conduit (1100) and/or the wiring (1000).

The crack propagation projections (500) may be made from a variety of materials, such as but not limited to: hardened steel; tungsten; alumina and industrial diamond. During use crack propagation projections (500) experience a huge amount of force that eventually causes wear and deformity. As such, crack propagation projections (500) may be occasionally replaced to ensure proper operation of the conduit fitting splitter (100). The crack propagation projections (500) may be easily removable from the conduit fitting splitter (100), and attachable to the conduit fitting splitter (100), so that they do not become dislodged in use and transport, or permanently stuck within the conduit fitting splitter (100) during use. In one embodiment of point projections (610) crack propagation projections (500), the point projection (610) may be held in place by screw threads, as seen in FIG. 6. In another embodiment the point projection (610) are held in place with a perpendicular rod in the middle of the point projection (610) crack propagation projection (500) body that “key-holes” into either or both of the proximal jaw (200) and or distal jaw (300), not show in illustrations. An edge projection crack propagation projection (620), such as seen in FIGS. 3 and 5 may be held into place with an edge projection retainer (630) such as found in FIG. 12. In another embodiment, the edge projection (620) crack propagation projection (500) may be bonded to a piece of metal that is designed to bolt onto either a proximal jaw (200) or distal jaw (300).

In yet another embodiment, the conduit fitting splitter (100), as shown in FIG. 12-14, a proximal jaw (200) and a distal jaw (300) are permanently connected to each other by a fixed interconnect (470) having a fixed interconnect interior side (475) and a fixed interconnect exterior side (476). The fixed interconnect (470) prevents any movement of the proximal or distal jaws (200, 300) in relation to one another. Furthermore, the permanently fixed proximal and distal jaws (200, 300) and fixed interconnect (470) forms a conduit fitting splitter (100) throat opening (490) into which a conduit fitting (900) to be split is placed.

The proximal jaw (200) may have a proximal jaw sinistral side (260), a proximal jaw dextral side (270), a proximal jaw front side (255), a proximal jaw rear side (256), an proximal jaw exterior surface (240), a proximal jaw interior surface (250), a proximal jaw length (210), defined by the distance from the proximal jaw sinistral side (260) to the proximal jaw dextral side (270), a proximal jaw width (220), defined by the distance from the proximal jaw front side (255) to the fixed interconnect (470) interior side (475), a proximal jaw height (230), defined as the distance between the proximal jaw interior surface (250) and the proximal jaw exterior surface (240), and multiple adjustable point projections (710) that have mechanical adjusters (730). The adjustable point projections (710) may be located in point projection apertures (715) located in the proximal jaw (200) in close proximity to the proximal jaw front side (255), as seen in FIGS. 12-14.

The distal jaw (300) may have a distal jaw sinistral side (360), a distal jaw dextral side (370), a distal jaw front side (355), a distal jaw rear side (356), an distal jaw interior surface (340), a distal jaw exterior surface (350), a distal jaw length (310), defined by the distance from the distal jaw sinistral side (360) to the distal jaw dextral side (370), a distal jaw width (320), defined by the distance from the distal jaw front side (355) to the fixed interconnect (470) interior side (475), a distal jaw height (330), defined as the distance between the distal jaw exterior surface (350) and distal jaw interior surface (340), and has a fixed edge projection (620) crack propagation projection (500) and an edge projection retainer (630) located on the distal jaw interior surface (340) in close proximity to the distal jaw front side (355), as seen in FIGS. 12 and 14.

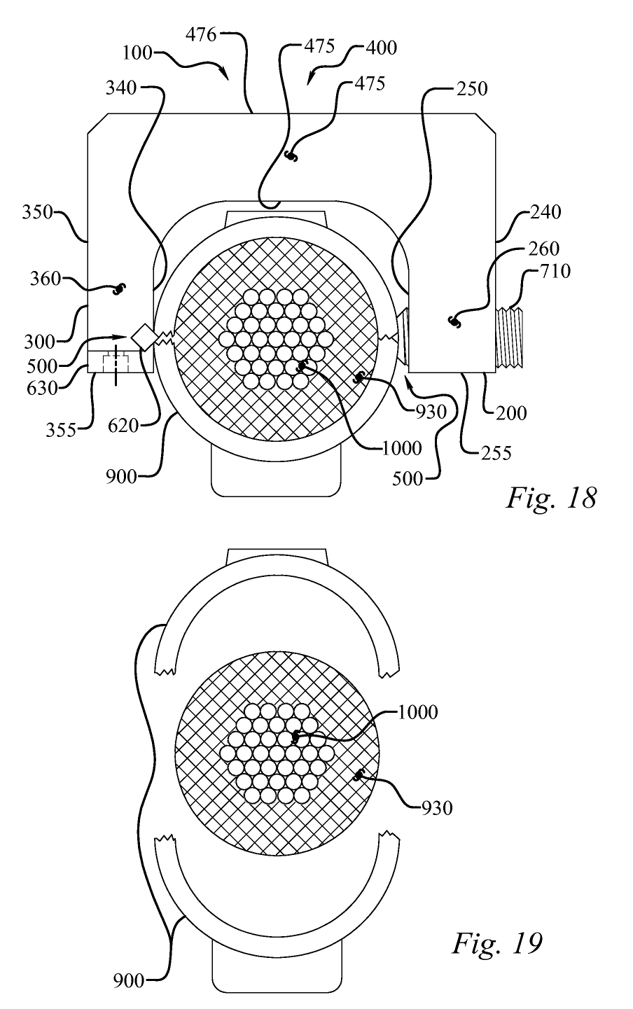

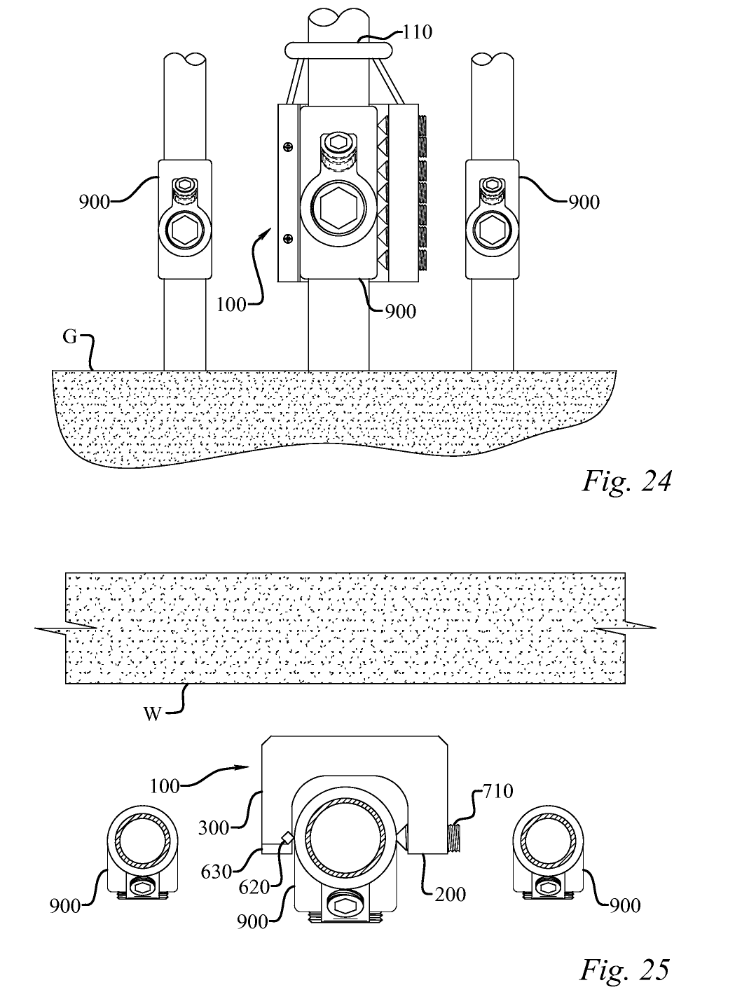

In one embodiment the method of using the conduit fitting splitter (100) shown in FIG. 12 is as follows. First, a worker selects a conduit fitting splitter (100) that has a proper proximal and distal jaw lengths (210, 310); a proper proximal and distal jaw widths (220, 320) and throat opening (490) for the conduit fitting (100) to be split. In determining the proper proximal and distal jaw lengths (210, 310), a worker selects a conduit fitting splitter (100) wherein the proximal and distal jaw lengths (210, 310) are long enough to allow crack propagation projections (500) on the proximal and distal jaws (200, 300) to align on the center of the conduit fitting (900), as seen in FIG. 18. The proximal and distal jaw widths (220, 320) should be at least as long as the conduit fitting (900), as seen in FIG. 24. Additionally, a conduit fitting splitter (100) should have a throat opening (490) that has enough clearance to allow a conduit fitting (900) to slide into it, as illustrated by FIGS. 12, 18, 24 and 25. After the conduit fitting splitter (100) in is slid into place around the outside of a conduit fitting (900), a worker starts to incrementally tighten a set of adjustable point projections (710). As such, the conduit fitting splitter (100) exerts a force by the adjustable point projections (710) that are located on the proximal jaw (200) and a fixed edge projection (620) located on the distal jaw (300) onto the opposite sides of the conduit fitting (900). The worker continues to tighten the adjustable point projections (710) until the conduit fitting (900) finally fractures and splits into multiple sections, as illustrated in FIGS. 18 and 19, and explained further later herein.

In another embodiment, the conduit fitting splitter (100), as shown in FIGS. 15-17, includes a proximal jaw (200) and a distal jaw (300) are permanently connected to each other by a fixed interconnect (470) having a fixed interconnect interior side (475) and a fixed interconnect exterior side (476). The fixed interconnect (470) prevents any movement of the proximal or distal jaws (200, 300) in relation to one another. Furthermore, the permanently fixed proximal and distal jaws (200, 300) and fixed interconnect (470) form a conduit fitting splitter (100) throat opening (490) into which a conduit fitting (900) to be split is placed. The proximal jaw (200) may have a proximal jaw sinistral side (260), a proximal jaw dextral side (270), a proximal jaw front side (255), a proximal jaw rear side (256), an proximal jaw exterior surface (240), a proximal jaw interior surface (250), a proximal jaw length (210), defined by the distance from the proximal jaw sinistral side (260) to the proximal jaw dextral side (270), a proximal jaw width (220), defined by the distance from the proximal jaw front side (255) to the fixed interconnect interior side (475), a proximal jaw height (230), defined as the distance between the proximal jaw (200) proximal jaw interior surface (250) and the proximal jaw exterior surface (240), and one, or more, adjustable point projection crack propagation projections (710) that have mechanical adjusters (730). The multiple of adjustable point projection crack propagation projections (710) are located in point projection apertures (715) located in the proximal jaw (200) in close proximity to the proximal jaw front side (255), as seen in FIGS. 15-17. The distal jaw (300) may have a distal jaw sinistral side (360), a distal jaw dextral side (370), a distal jaw front side (355), a distal jaw rear side (356), an distal jaw interior surface (340), a distal jaw exterior surface (350), a distal jaw length (310), defined by the distance from the distal jaw sinistral side (360) to the distal jaw dextral side (370), a distal jaw width (320), defined by the distance from the distal jaw front side (355) to the fixed interconnect (470) interior side (475), a distal jaw height (330), defined as the distance between the distal jaw exterior surface (350) and distal jaw interior surface (340), and a multiple of adjustable point projection (710) crack propagation projections (500) that have mechanical adjusters (730). In this embodiment the multiple adjustable point projections (710) are located in point projection apertures (715) located in the distal jaw (300) in close proximity to the distal jaw front side (355), as seen in FIGS. 15-17.

The method of using an embodiment of conduit fitting splitter (100) shown in FIG. 15-17 is as follows. First, a worker selects a conduit fitting splitter (100) that has a proper proximal and distal jaw lengths (210, 310); a proper proximal and distal jaw widths (220, 320) and throat opening (490) for the conduit fitting (100) to be split. In determining the proper proximal and distal jaw lengths (210, 310), a worker select a conduit fitting splitter (100) wherein the proximal and distal jaw lengths (210, 310) are long enough to allow crack propagation projections (500) on the proximal and distal jaws (200, 300) to align on the center of the conduit fitting (900). The proximal and distal jaw widths (220, 320) should be at least as long as the conduit fitting (900). Additionally, the conduit fitting splitter (100) may have a throat opening (490) that has just enough clearance to allow a conduit fitting (900) to slide into it. After the conduit fitting splitter (100) is slid into place around the outside of a conduit fitting (900), a worker starts to incrementally tighten a set of adjustable point projection (710). As such, the conduit fitting splitter (100) exerts a force by the adjustable point projection (710) crack propagation projections (500) that are located on the proximal jaw (200) and the adjustable point projection (710) crack propagation projections (500) that are located on the distal jaw (300) equating to a force on opposite sides of the conduit fitting (900). The worker continues to tighten the adjustable point projections (710) until cracks propagate through the conduit fitting (900) and it fractures and splits into multiple pieces, as illustrated in FIG. 19.

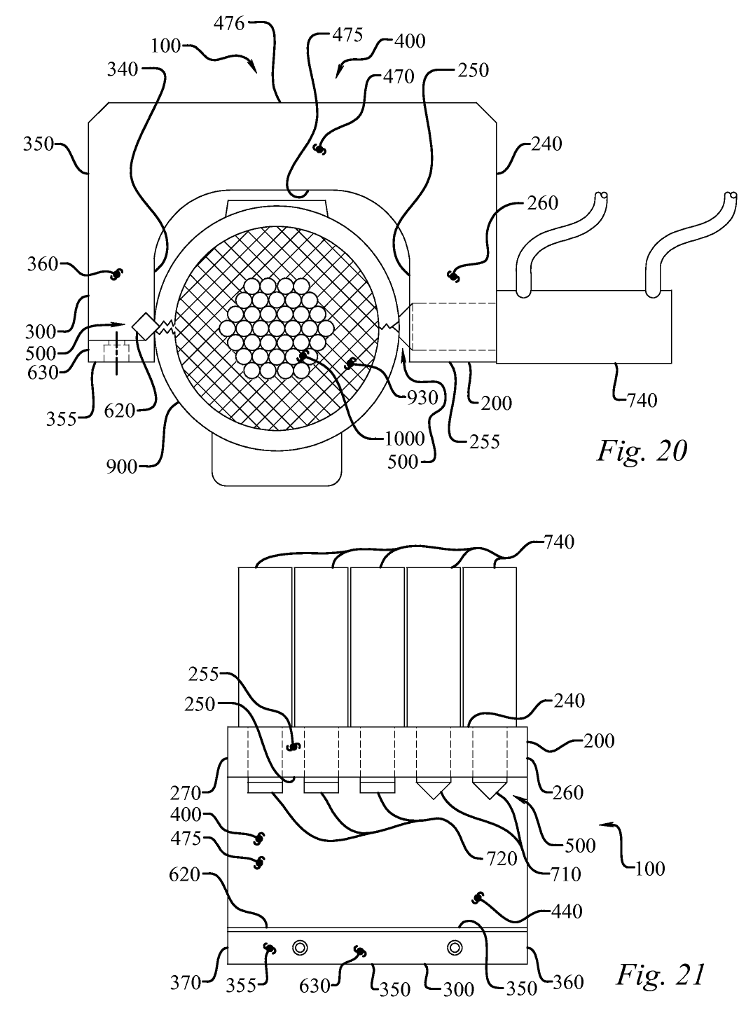

In still yet another embodiment, the conduit fitting splitter (100), as shown in FIGS. 20 and 21, has a proximal jaw (200) and a distal jaw (300) that are permanently connected to each other by a fixed interconnect (470) having a fixed interconnect interior side (475) and a fixed interconnect exterior side (476). The fixed interconnect (470) prevents any movement of the proximal or distal jaws (200, 300) in relation to one another. Furthermore, the permanently fixed proximal and distal jaws (200, 300) and fixed interconnect (470) forms a conduit fitting splitter (100) throat opening (490) into which a conduit fitting (900) to be split is placed. The proximal jaw (200) may have a proximal jaw sinistral side (260), a proximal jaw dextral side (270), a proximal jaw front side (255), a proximal jaw rear side (256), an proximal jaw exterior surface (240), a proximal jaw interior surface (250), a proximal jaw length (210), defined by the distance from the proximal jaw sinistral side (260) to the proximal jaw dextral side (270), a proximal jaw width (220), defined by the distance from the proximal jaw front side (255) to the fixed interconnect (470) interior side (475), a proximal jaw height (230), defined as the distance between the proximal jaw interior surface (250) and the proximal jaw exterior surface (240), a multiple adjustable point projections (710) having hydraulic adjusters (740), as seen in FIGS. 20 and 21. The multiple adjustable point projections (710) are located in point projection apertures (715) located in the proximal jaw (200) in close proximity to the proximal jaw front side (255), as seen in FIGS. 20 and 21. The distal jaw (300) may have a distal jaw sinistral side (360), a distal jaw dextral side (370), a distal jaw front side (355), a distal jaw rear side (356), an distal jaw interior surface (340), a distal jaw exterior surface (350), a distal jaw length (310), defined by the distance from the distal jaw sinistral side (360) to the distal jaw dextral side (370), a distal jaw width (320), defined by the distance from the distal jaw front side (355) to the fixed interconnect (470) interior side (475), a distal jaw height (330), defined as the distance between the distal jaw exterior surface (350) and distal jaw interior surface (340), and has a fixed edge projection (620) and an edge projection retainer (630) located on the distal jaw interior surface (340) in close proximity to the distal jaw front side (355), as seen in FIGS. 20 and 21.

The method of using the embodiment of conduit fitting splitter (100) shown in FIGS. 20 and 21 is as follows. First, a worker selects a conduit fitting splitter (100) that has a proper proximal and distal jaw lengths (210, 310); a proper proximal and distal jaw widths (220, 320) and throat opening (490) for the conduit fitting (100) to be split. In determining the proper proximal and distal jaw lengths (210, 310), a worker select a conduit fitting splitter (100) wherein the proximal and distal jaw lengths (210, 310) are long enough to allow crack propagation projections (500) on the proximal and distal jaws (200, 300) to align on the center of the conduit fitting (900). The proximal and distal jaw widths (220, 320) should be at least as long as the conduit fitting (900). Additionally, a conduit fitting splitter (100) should have a throat opening (490) that would have just enough clearance to allow a conduit fitting (900) to slide into it. After the conduit fitting splitter (100) in is slid into place around the outside of a conduit fitting (900), pressure is increased on the force assisted adjusters (740) attached to the adjustable point projections (710). As such, the conduit fitting splitter (100) exerts a force by the adjustable point projections (710) that are located on the proximal jaw (200) and a fixed edge projection (620) located on the distal jaw (300) onto the opposite sides of the conduit fitting (900). Pressure is increased on the force assisted adjusters (740) attached to the adjustable point projections (710) until at least two carefully located cracks are initiated and travel through the conduit fitting (900) to fracture it into multiple pieces, as illustrated in FIGS. 18 and 19.

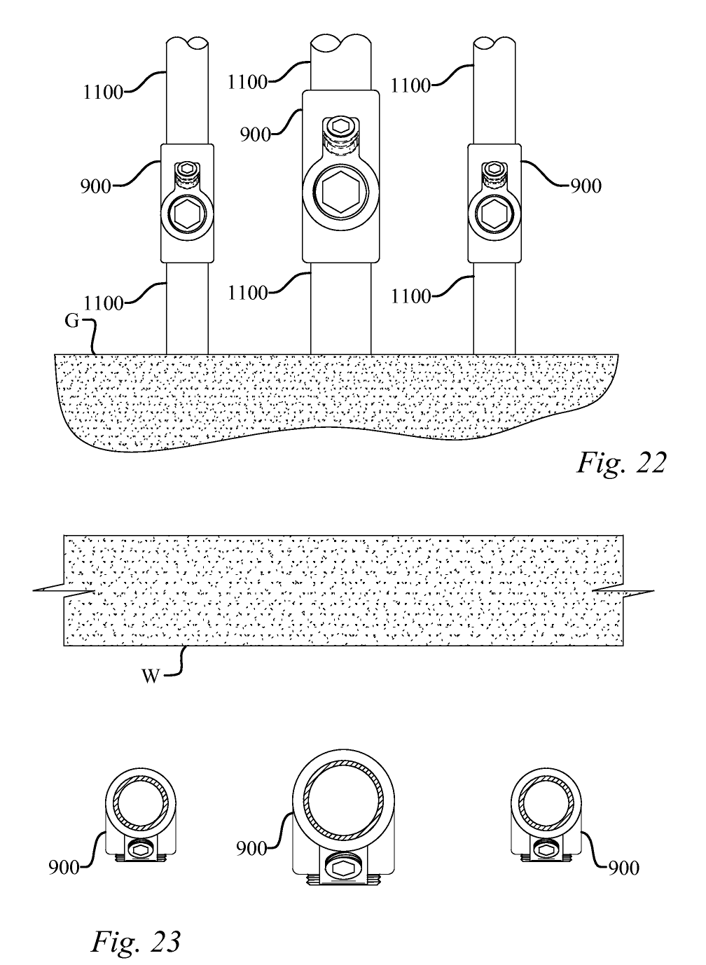

Now referencing FIGS. 22-25, which shows various views of a conduit raceways and conduit raceways with a conduit splitter attached. FIG. 22 shows elevated front view of a typical conduit raceway having both conduit (1100) and conduit fittings (900). FIG. 23 shows a top plan view of a typical conduit raceway. Conduit raceways having explosion proof conduit fittings (900) such as those found in FIGS. 22 and 23 present special removal problems for maintenance workers. Special care must be taken as to not damage the wiring inside, but unfortunately, due to the limited space, conventional methods often include spark producing methods such as cutting and grinding, which may also damage the conduit and/or wiring. Due to the limited spacing between individual conduit runs, a worker's removal options are limited. FIG. 24 shows elevated front view of a typical conduit raceway with a conduit fitting splitter (100) in position for splitting the center conduit fitting (900). FIG. 25 shows a top plan view of a typical conduit raceway with a conduit fitting splitter (100) in position for splitting the center conduit fitting (900). As one can tell from FIGS. 24 and 25, the conduit fitting splitter (100) allows a worker access to conduit fittings in tight spaces. As such, the conduit fitting splitter (100) is an advancement in the state of the art which saves time money and materials.

Next we turn our attention to FIG. 26 which is hand operated hydraulically actuated conduit fitting splitter (100). This embodiment of conduit fitting splitter (100) has a proximal and distal jaw (200, 300); a plurality of point projections (710); a fixed edge projection (620); and an actuator (800). In use, a worker places the proximal jaw (200) and distal jaw (300) on each side of a conduit fitting (900) and pumps the hand operated hydraulically actuated conduit fitting splitter's (100) handle causing the point projection (710) crack propagation projections (500 to exert a force on the conduit fitting (900). The worker continues to pump the handle on the hand operated hydraulically actuated conduit fitting splitter (100) until the conduit fitting (900) splits into two pieces.

Thus, embodiments of the conduit fitting splitter (100) facilitate the controlled fracture of a conduit fitting (900) with minimal, or no, deformation or damage to the adjacent conduit (1100), and without damaging the internal wiring (1000). This is accomplished through a plurality of unique relationships that promote the initiation of a plurality of cracks within the conduit fitting (900) and control the propagation of the cracks through the conduit fitting (900) until it fractures into multiple pieces, thereby allowing the reuse of adjacent conduit, and more importantly the internal wiring (1000).

As previously discussed, in this situation the design of the conduit fitting splitter (100) must be such that it doesn't simply deform the conduit fitting (900) because doing so will cause damage to the conduit (1100) or the wiring (1000). In fact, the design must precisely control the creation and propagation of the cracks while protecting the sealing compound (930) within the conduit fitting (900) from excessive force, which would effectively cause the sealing compound (930) to begin to crush the wiring (1000), and/or its insulation. The present embodiments accomplish this in a number of ways.

Most embodiments will include a proximal jaw (200) and an opposing distal jaw (300) joined together via a jaw interconnect (400). Further, at least one crack propagation projection (500), fixed or adjustable, will extend from the proximal jaw (200) and at least one crack propagation projection (500), fixed or adjustable, will extend from the distal jaw (300).

In one embodiment, seen in FIG. 2, the at least one crack propagation projection (500) of the distal jaw (300) includes at least two adjustable crack propagation projections (700) extending from a distal jaw interior surface (340) toward a proximal jaw interior surface (250), and each adjustable crack propagation projection (700) has a projection cross-sectional distance (702) and a projection travel (706). A projection offset (704) is a distance from the center of the adjustable crack propagation projection (700) to the adjacent crack propagation projection (700). In one embodiment the projection offset (704) is no more than three times the projection cross-sectional distance (702), and the projection travel (706) is at least 50% of the projection cross-sectional distance (702).

The position of the at least two adjustable crack propagation projections (700) may be individually adjusted to contact an exterior surface of the conduit fitting (900). The exterior surface of the conduit fitting (900) is likely to be irregular, i.e. something other than parallel surfaces either due to the casting process and associated seam grinding/polishing or simply due the shape of the conduit fitting (900), and the ability to adjust the crack propagation projections (700) facilitates the force loading on the conduit fitting (900) that creates and controls the cracks to fracture the fitting in a predetermined manner. The at least two adjustable crack propagation projections (700) apply a load to the conduit fitting (900) to initiate and control the propagation of at least one crack, on each side, through the conduit fitting (900) to break the conduit fitting into at least two pieces for removal from conduit (1100). The load may be applied directly by the adjustable crack propagation projections (700) being independently forced against the exterior surface of the conduit fitting (900), such as by individually tightening them, or via the movement of one, or both, of the jaws (200, 300).

In one particular embodiment, seen in FIG. 11, the projection travel (706) is at least 100% of the projection cross-sectional distance (702). The projection travel (706) is defined as the distance that the adjustable crack propagation projections (700) may be adjusted. In the embodiment of FIG. 11 the projection travel (706) is measured from the interior surface of the lower jaw. In yet a further embodiment the projection travel (706) is less than three times the projection cross-sectional distance (702), while in an even further embodiment the projection travel (706) is at least 100% of the projection cross-sectional distance (702) and less than three times the projection cross-sectional distance (702). The proximal jaw (200) and the opposing distal jaw (300) define a throat opening (490), which in the pivoting jaw embodiments is established at the location in which the axis of each jaw is parallel. In one embodiment the projection travel (706) is at least 5% of the throat opening (490), while in a further embodiment the projection travel (706) is less than 50% of the throat opening (490). In yet another embodiment the projection travel (706) is at least 10% of the throat opening (490) and less than 35% of the throat opening (490). The load placed on the adjustable crack propagation projections (700) is significant, whether it be via individually tightening of the projection to initiate a crack or the application of force on the adjustable crack propagation projections (700) via the pivoting jaws, and these relationships provide stability of the adjustable crack propagation projections (700) over a wide adjustability range

Referring back to FIG. 2, as previously mentioned, in one embodiment the projection offset (704) is no more than three times the projection cross-sectional distance (702), and the projection travel (706) is at least 50% of the projection cross-sectional distance (702). The projection cross-sectional distance (702) may generally be thought of as the diameter of the adjustable crack propagation projection (700), however one skilled in the art will appreciate that the adjustable crack propagation projection (700) need not have a round cross-sectional profile, thus the nomenclature of projection cross-sectional distance (702), which in non-circular cross-sectional profile embodiments is the maximum distance measured in a single plane that is perpendicular to the axis of the adjustable crack propagation projection (700), i.e. perpendicular to the direction of longitudinal adjustment. As seen in FIG. 2 the projection offset (704) is a distance from the center of the adjustable crack propagation projection (700) to the adjacent crack propagation projection (700). In embodiments in which the adjustable crack propagation projection (700) is circular and the tip of the adjustable crack propagation projection (700) is conical, determining the center of the adjustable crack propagation projection (700) is easy. However, the adjustable crack propagation projection (700) may have a non-circular cross-section and the tip may be configured as a non-conical surface, and in such embodiments the center is determined by sectioning the adjustable crack propagation projection (700) at the midpoint of its overall length in a plane perpendicular to the direction of adjustment, and the centroid of this cross-section establishes the center for purposes of determining the projection offset (704). In several of the illustrated embodiments the projection cross-sectional distance (702) is the diameter of the adjustable crack propagation projection (700), which in one embodiment is ⅜″ to 1⅜″, while in a further embodiment it is ⅝″ to 1⅛″. In one particular embodiment the adjustable crack propagation projection (700) is a ⅝″-11 set screw, while in another embodiment it is a ¾″-10 set screw. In another embodiment the overall length of the adjustable crack propagation projection (700) from the base to the tip is ⅝″ to 1⅝″, which in a further embodiment is ⅞″ to 1⅜″. In another embodiment the projection travel (706) is no more than 80% of the overall length so that at least 20% of the overall length remains engaged with a jaw (200, 300) to withstand the loads encountered.

As seen in FIG. 4, the wall thickness of conduit fittings (900), particularly explosion proof conduit fittings (900), varies significantly and the relationship of the projection offset (704) and the projection cross-sectional distance (702) controls the propagation of the crack between the adjustable crack propagation projections (700) in a longitudinal direction and prevent the crack from propagating in an undesirable direction, such as circumferentially around the fitting (900) when a thicker sidewall region is encountered. The wall thickness varies with the size of the fitting, and the maximum wall thickness can be up to 0.40″ for smaller fittings, and close to 1.00″ for larger expanded fill sealing fittings, also referred to as EYSX fittings. In one embodiment the conduit fitting splitter (100) is a kit including multiple interchangeable fixed edge projection crack propagation projections (620) that are tailored to the most common fittings produced by the most common fitting manufacturers and their unique wall thickness profiles and sizes. In fact, in one embodiment the interchangeable fixed edge projection crack propagation projections (620) has a different varying fixed projection height (640) that is tailored to track the wall thickness profile of common fittings. Thus, in one embodiment the kit includes at least three interchangeable fixed edge projection crack propagation projections (620) where each one it tailored for a different fitting size of a single manufacturer.

One embodiment of the conduit fitting splitter (100) is configured to accept and fracture fittings ranging from ½″ conduit up through 2″ conduit. In this embodiment the throat opening (490) is at least 3.00″, while in a further embodiment it is at least 3.25″. As seen in a typical installation illustrated in FIGS. 24 and 25, there is generally little room to maneuver around a conduit fitting (900) as they generally have other conduits located on either side, are generally located as soon as the conduit (1100) penetrates the floor (G) to enter a mechanical room, and are generally located in close proximity to a wall (W). Thus, a compact and easily maneuverable tool is needed that is capable of withstanding the loads necessary to initiate and control the fracture of a conduit fitting (900) that is designed to be extremely durable and resist explosions.

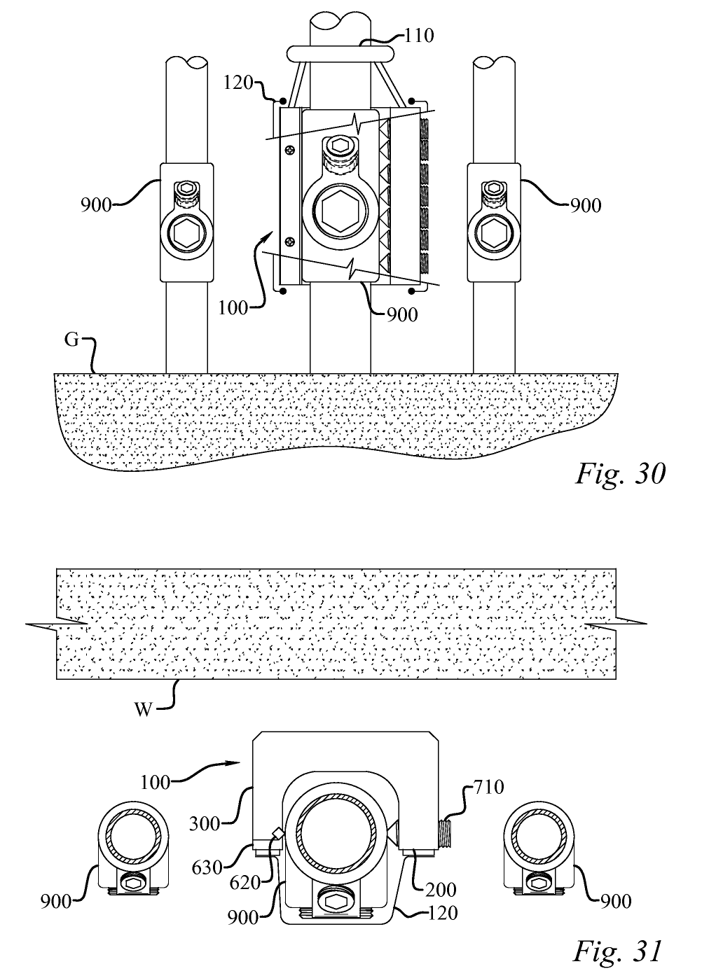

For instance, in FIGS. 24 and 25, the conduit fitting splitter (100) may be configured so that it can be easily positioned and attached to a conduit fitting (900) in an existing situation whereby it is bounded by other conduit and a wall (W) and/or floor (G). The adjustable point projection crack propagation projection (710) of FIG. 25 may have a recessed tool engagement pocket to receive a tool. The tool must engage the adjustable point projection crack propagation projection (710), and in some embodiments cooperate with a cheater bar, while fitting within the existing obstacles. One embodiment incorporates a splitter support system (110), seen in FIG. 24, that attaches to the conduit (1100) to support the conduit fitting splitter (100) so it does not fall to the ground upon fracture of the conduit fitting (900). The splitter support system (110) may include a quick-release clamp system that attaches to the conduit (1100), and one, or more, retainers that secure the conduit fitting splitter (100) to the clamp system. The retainers may be flexible retainers such as cable, chain, or rope, or a rigid retainer such as a rod, or rods. The clamp system may releasably engage the conduit (1100) on either side of the conduit fitting (900). Additionally, as seen in FIGS. 30 and 31, the conduit fitting splitter (100) may further include a splitter shroud (120) to serve as a safety shield and prevent the fractured conduit fitting (900) from injuring the worker, and in some embodiments containing the debris. In one embodiment the splitter shroud (120) is constructed of flexible tear-resistant material that may be releasably attached to the conduit fitting splitter (100), or around the conduit fitting splitter (100). One embodiment utilizes canvas attached via a hook-and-loop fastener system.

Referring back to FIG. 2, in yet another embodiment the propagation of the crack is further controlled by having the projection offset (704) is no more than two times the projection cross-sectional distance (702), while in another embodiment the projection offset (704) is at least 5% greater than the projection cross-sectional distance (702). In a further embodiment crack control is achieved with a projection offset (704) of 7-50% greater than the projection cross-sectional distance (702), while in an even further embodiment the projection offset (704) is 9-25% greater than the projection cross-sectional distance (702).

In some embodiments the at least one crack propagation projection (500) of the distal jaw (300) includes three to ten adjustable crack propagation projections (700) extending from a distal jaw interior surface (340) toward a proximal jaw interior surface (250), and in a further embodiment each projection offset (704) is no more than three times the projection cross-sectional distance (702), while in an even further embodiment each projection offset (704) is no more than two times the projection cross-sectional distance (702).

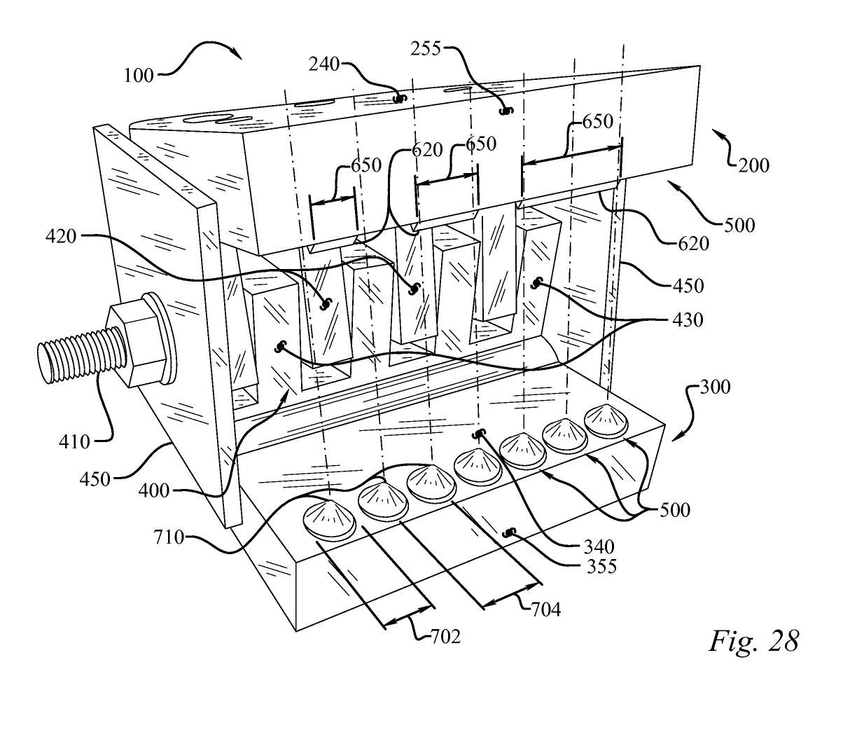

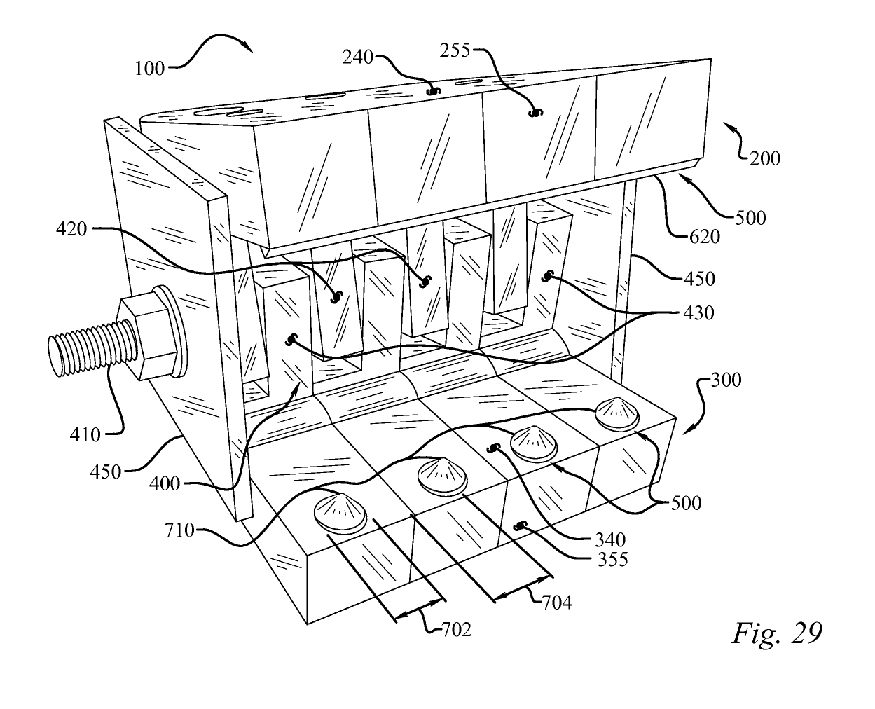

Turning now to embodiments having at least one crack propagation projection (500) extending from the proximal jaw (200), this projection may be any of the disclosed adjustable crack propagation projections (700) or it may be a fixed crack propagation projection (600), wherein the term fixed means that it is not adjustable however it may be replaceable. As seen in FIG. 11, the fixed crack propagation projection (600) extends a fixed projection height (640) from a proximal jaw interior surface (250) toward a distal jaw interior surface (340). The fixed crack propagation projection (600) may be a fixed point projection (610), as seen in FIG. 27, or it may be a fixed edge projection (620), as seen in FIG. 2. The fixed point projection (610) includes any of the embodiments and relationships disclosed with respect to the adjustable crack propagation projection (700), with the obvious exception of not having a projection travel (706). The fixed edge projection (620) embodiments have a fixed projection length (650), as seen in FIG. 3, as a continuous full-length edge projection, and FIG. 28, as at least one partial length edge projection.

In one embodiment the edge projection (620) has a fixed projection length (650) that is at least 50% of the projection offset (704), which is true for the embodiment of FIG. 2 and any of the embodiments illustrated in FIG. 28. Further, in another embodiment the fixed projection length (650) that is at least 100% of the projection offset (704), which again is true for the embodiment of FIG. 2, and either of the two longer edge projections (620) seen in FIG. 28. In yet a further embodiment the edge projection (620) has a fixed projection length (650) that is at least as great as the distance from the center of a first adjustable crack propagation projection (700), across a second adjustable crack propagation projection (700), to the center of a third adjustable crack propagation projection (700), which is true of the edge projection (620) shown on the right side of FIG. 28, and of course is also true for the embodiment illustrated in FIG. 2. In another embodiment the edge projection (620) extends continuously between the two most distant adjustable crack propagation projections (700).

In the embodiment of FIG. 27 the at least one crack propagation projection (500) extends from the proximal jaw (200) and includes a plurality of fixed crack propagation projections (600) extending a fixed projection height (640) from a proximal jaw interior surface (250) toward a distal jaw interior surface (340), and consist of a plurality of point projections (610), wherein the proximal jaw (200) and an opposing distal jaw (300) define a throat opening (490), and the fixed projection height (640) is at least 2.5% of the throat opening (490). The fixed projection height (640) applies equally to embodiments having fixed point projections (610) and embodiments having fixed edge projections (620). In fact in one embodiment the fixed projection height (640) is less than 10% of the throat opening (490), regardless of the style of the projection. Embodiments incorporating multiple fixed point projections (610) have a fixed projection offset (614), as seen in FIG. 27, which is a distance from the center of a point projection (610) to the adjacent point projection (610). In one embodiment the fixed projection offset (614) is within 25% of the projection offset (704). In another embodiment the multiple fixed point projections (610) on the proximal jaw (200) align with the multiple adjustable projections (700) located on the distal jaw (300), however in another embodiment the plurality of point projections (610) are offset from the at least two adjustable crack propagation projections (700).

The embodiment of FIG. 28 has at least one crack propagation projection (500) extending from the proximal jaw (200) that includes a fixed crack propagation projection (600) extending a fixed projection height (640) from a proximal jaw interior surface (250) toward a distal jaw interior surface (340), wherein the fixed crack propagation projection (600) is an edge projection (620) having a fixed projection length (650) that is at least as great as the distance from the center of the first adjustable crack propagation projection (700), across the second adjustable crack propagation projection (700), to the center of the third adjustable crack propagation projection (700), as illustrated by the furthest right edge projection (620) in FIG. 28. Yet a further embodiment has a fixed projection length (650), seen best in FIG. 28, that is at least twice the fixed projection height (640), seen best in FIG. 11; while an even further embodiment has a fixed projection length (650) that is at least four times the fixed projection height (640); and in an even further embodiment has a fixed projection length (650) that is at least ten times the fixed projection height (640).

Proper positioning of the conduit fitting (900) within the conduit fitting splitter (100) ensures that the method does not leave a fractured portion of the conduit fitting (900) still engaging the adjacent conduit. For instance, looking at FIGS. 18 and 19, ideally no portion of the fractured conduit fitting (900) extends more than 185 degrees around the adjacent conduit, and achieving a perfect split of the conduit fitting (900) into two 180 degree sections would be perfection, although fracturing the conduit fitting into more than two sections is also acceptable. After all, one skilled in the art will appreciate that if one of the sections of the conduit fitting (900) shown in FIG. 19 was greater than 185 degrees of an art then the section would effectively remain engaged to the threaded conduit (1100), seen in FIG. 4, at the ends of the conduit fitting (900). Thus, convenient positioning of the conduit fitting splitter (100) and the ability to precisely control crack formation and propagation through the conduit fitting (900) provide great productivity benefits and reduce the likelihood of rework. In a preferred embodiment the conduit fitting splitter (100) is designed and operated to create two longitudinal cracks through the conduit fitting (900) directly opposite one another, as seen in FIGS. 18 and 19, however in further embodiments more than two longitudinal cracks are created to further ensure easy removal of the pieces of the fractured conduit fitting (900). The fitting splitter (100) must be easily repositionable and capable of repeatedly producing and controlling crack propagation so that the two cracks do not deviate more than 3/16″ from being perfectly opposed to one another throughout the length of the conduit fitting (900).

As previously touched upon, load may be applied to one side of the conduit fitting (900), as seen in FIG. 18 having adjustable crack propagation projections extending from a single jaw, or both sides of the conduit fitting (900), as in the pivoting jaw embodiments as well as embodiments such as that seen in FIG. 15 having adjustable crack propagation projections (700) extending from both jaws. In embodiments with a fixed crack propagation projection (600) a first crack is formed along the fixed crack propagation projection (600). In embodiments such as that seen in FIG. 18, the load is applied to the conduit fitting (900) via the adjustable crack propagation projections (700), which draws the fixed crack propagation projection (600) into the conduit fitting (600). Utilizing a standard length ⅜″ hand alien wrench the load applied by each adjustable crack propagation projection (700) may be in excess of 7000 lbf; in fact testing produced a load of approximately 8000 lbf with a ⅝″-11 set screw and approximately 12000 lbf with a ¾″-10 set screw.

Clearly the pressure experienced is extreme as the tip of the fixed crack propagation projection (600) is drawn into the conduit fitting (900). Thus, in one embodiment the Rockwell hardness of the fixed crack propagation projection (600) is at least 38 HRC, while in a further embodiment it is at least 45 HRC, and in an even further embodiment is at least 55 HRC. In another embodiment Rockwell hardness of the fixed crack propagation projection (600) is less than 65 HRC.

As previously discussed, proper positioning of the conduit fitting (900) within the conduit fitting splitter (100) ensures that the method does not leave a fractured portion of the conduit fitting (900) still engaging the adjacent conduit. One embodiment incorporates at least one fitting positioner (480), as seen in FIG. 11, to control the location of conduit fitting (900) within the conduit fitting splitter (100) to ensure proper placement with respect to the at least one crack propagating projection (500). While the fitting positioner (480) is illustrated with a pivoting jaw embodiment, one skilled in the art will appreciate that it is equally effective in fixed jaw embodiments. The fitting positioner (480) is located so that the splitter (100) is placed around a conduit fitting (900) and positioned so that the exterior surface of the adjacent conduit (1100), at one or both ends, abuts an edge of the fitting positioner (480). In the embodiment of FIG. 11 the fitting positioner (480) is a rectangular plate having multiple positioning edges that may be positioned to abut the conduit (1100); namely a first positioning edge (481), a second positioning edge (482), and a third positioning edge (483). In this embodiment the fitting positioner (480) is rotated about a positioner rotational reference (484), which may be a hole or a stud that defines the rotational point of the fitting positioner (480). The positioning edges (481, 482, 483) are located at different distances from the positioner rotational reference (484). For example, in FIG. 11 the first positioning edge (481) may be a distance from the positioner rotational reference (484) to properly locate the fitting conduit (900) in the splitter (100) when a 2″ conduit fitting (900) is used and the adjacent 2″ conduit (1100) abuts the first positioning edge (481). Further, the second positioning edge (482) may be a distance from the positioner rotational reference (484) to properly locate the fitting conduit (900) in the splitter (100) when a 1½″ conduit fitting (900) is used and the adjacent 1½″ conduit (1100) abuts the second positioning edge (482). Even further, the third positioning edge (483) may be a distance from the positioner rotational reference (484) to properly locate the fitting conduit (900) in the splitter (100) when a 1″ conduit fitting (900) is used and the adjacent 1″ conduit (1100) abuts the third positioning edge (483). The fitting positioner (480) may further include a positioner interlock (485) to secure the fitting positioner (480) in the desired location. Alternatively, rather than a rotating plate embodiment for the fitting positioner (480), it may be a set of separate plates that are attached to the splitter (100) to achieve the desired position. For instance in some applications, such as that seen in FIG. 25, there may not be enough room to accommodate a rotating fitting positioner (480), however an interchangeable plate fitting positioner (480), attached to the fixed interconnect (470), would achieve the goal without potentially impacting the wall (W).

Guarding against potential damaged to the ends of the threaded conduit (1100) is further achieved in one embodiment by incorporating a fixed edge projection (620) having a variable fixed projection height (640) seen in FIG. 11. For example, looking at FIG. 2, in one embodiment the fixed projection height (640) may be greatest in the center of the conduit fitting splitter (100) and reduce as it approaches the conduit connections. Thus, as the fixed edge projection (620) approaches the conduit connections the fixed projection height (640) is enough to control the propagation of the crack, yet small enough prevent damage of the threaded conduit. In one particular embodiment the fixed projection height (640) has a maximum that is at least 50% greater than the minimum fixed projection height (640) throughout its length, while in an even further embodiment the fixed projection height (640) has a maximum that is at least 100% greater than the minimum fixed projection height (640) throughout its length.

As seen in the embodiment of FIG. 29, the conduit fitting splitter (100) may be designed in a modular manner to provide flexibility. The illustrated embodiment shows the distal jaw (300) being composed of 4 individual and distinct sections that are joined to 4 individual and distinct sections of the proximal jaw (200) at the pivoting interconnect (410), which may include proximal jaw fingers (420) and distal jaw fingers (430). One skilled in the art will appreciate that this modular design allows a user to build-up the conduit fitting splitter (100) in a modular manner that may include two sections, or may include twenty sections, depending on the particular conduit fitting (900) and physical constraints in the installation.

This invention includes a spark-free method of demolishing an explosion resistance conduit fitting (900) in a hazardous location without damaging the conduit (1100) connected to the conduit fitting (900) and without damaging the wiring (1000) within the conduit fitting (900). The method includes creating at least one high stress zone on each side of the conduit fitting (900) to initiate the formation of a longitudinal crack on each side of the conduit fitting (900). The method also includes the step of longitudinally propagating each of the cracks throughout the length of the conduit fitting (900), and controlling the propagation of each crack so that they remain within an acceptable propagation zone. The high stress zones are created by applying a force of at least 6000 lbf on at least one side of the conduit fitting. The acceptable propagation zone is defined by first establishing the center axis of the conduit, and then a plane passing through the center axis. The acceptable propagation zone is an area defined by rotating the plane 5 degrees each way from its initial position. Thus, with reference to FIG. 15, if 0 degrees is to the right, 90 degrees is vertically upward, 180 degrees is to the left, and 270 degrees is vertically downward, then the acceptable propagation zone is from 355 degrees to 5 degrees on one side and from 175 degrees to 185 degrees on the other side. In another embodiment of the method, a crack if first created in the acceptable propagation zone that is opposite the side where the load is applied, then a second crack is created on the load side of the conduit fitting.

In an embodiment of the method incorporating multiple adjustable crack propagation projections (700), the method includes applying a load on the conduit fitting with each crack propagation projection (700) and ensuring that the load applied varies by no more than 1000 lbf from the highest loaded adjustable crack propagation projection (700) to the lowest loaded adjustable crack propagation projection (700), while in another embodiment the load applied varies by no more than 750 lbf from the highest loaded adjustable crack propagation projection (700) to the lowest loaded adjustable crack propagation projection (700), and in another embodiment the load applied varies by no more than 500 lbf from the highest loaded adjustable crack propagation projection (700) to the lowest loaded adjustable crack propagation projection (700). In another embodiment the load is applied in a manner so that the torque on any adjustable crack propagation projection (700) is no more than 100 lbf-ft greater than the torque on any other adjustable crack propagation projection (700); in another embodiment the torque on any adjustable crack propagation projection (700) is no more than 75 lbf-ft greater than the torque on any other adjustable crack propagation projection (700); in yet another embodiment the torque on any adjustable crack propagation projection (700) is no more than 50 lbf-ft greater than the torque on any other adjustable crack propagation projection (700); and in another embodiment the torque on any adjustable crack propagation projection (700) is no more than 25 lbf-ft greater than the torque on any other adjustable crack propagation projection (700). In another embodiment of the method the load is first applied to the innermost adjustable crack propagation projection (700) and then the others are loaded as they move away from the innermost adjustable crack propagation projection (700). For instance in this embodiment the center adjustable crack propagation projection (700) of FIG. 13 would be initially loaded, while maintaining the previously disclosed loading relationships recognizing that the others have no load, then the adjustable crack propagation projection (700) to the immediate right or left would be loaded, and on, and on, working toward the ends of the conduit fitting (900); and then the process is repeated over and over, while maintaining the previously disclosed loading relationships, until a crack has been initiated and propagated in a controlled manner to fracture the conduit fitting (900) into at least two pieces. Alternatively, in the kit embodiments described above that are fitting specific, the kit may include a custom loading pattern indicating the order, and/or torque, that should be applied to take into account the wall thickness profile of a particular fitting (900).

In another embodiment of the method the crack is first created in the acceptable propagation zone, opposite the side where the load is applied, and is initiated and controlled with a fixed crack propagation projection (600) configured as an edge projection (620), while the second crack created on the load side of the conduit fitting is created and controlled by a plurality of adjustable crack propagation projections (700) spaced so as to control the longitudinal propagation of the crack.

Numerous alterations, modifications, and variations of the embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims.

I claim:

1. A conduit fitting splitter (100) for the controlled fracture of a conduit fitting (900) without deforming adjacent conduit (1100) or damaging internal wiring (1000), comprising:
a proximal jaw (200) and an opposing distal jaw (300) joined together via a jaw interconnect (400);
at least one crack propagation projection (500) extending from the proximal jaw (200) and at least one crack propagation projection (500) extending from the distal jaw (300);
wherein the at least one crack propagation projection (500) of the distal jaw (300) includes at least two adjustable crack propagation projections (700) extending from a distal jaw interior surface (340) toward a proximal jaw interior surface (250), and each adjustable crack propagation projection (700) has a projection cross-sectional distance (702) and a projection travel (706), and a projection offset (704) is a distance from the center of the adjustable crack propagation projection (700) to the adjacent crack propagation projection (700), and (a) the projection offset (704) is no more than three times the projection cross-sectional distance (702), and (b) the projection travel (706) is at least 50% of the projection cross-sectional distance (702); and
wherein the position of the at least two adjustable crack propagation projections (700) may be individually adjusted to contact an exterior surface of the conduit fitting (900), and the at least two adjustable crack propagation projections (700) apply a load to the conduit fitting (900) to initiate and control the propagation of at least one crack through the conduit fitting (900) to break the conduit fitting into at least two pieces for removal from conduit (1100).

2. The conduit fitting splitter (100) of claim 1, wherein the projection travel (706) is at least 100% of the projection cross-sectional distance (702).

3. The conduit fitting splitter (100) of claim 1, wherein the projection travel (706) is less than three times the projection cross-sectional distance (702).

4. The conduit fitting splitter (100) of claim 1, wherein the projection travel (706) is at least 100% of the projection cross-sectional distance (702) and less than three times the projection cross-sectional distance (702).

5. The conduit fitting splitter (100) of claim 1, wherein the proximal jaw (200) and an opposing distal jaw (300) define a throat opening (490), and the projection travel (706) is at least 5% of the throat opening (490).

6. The conduit fitting splitter (100) of claim 5, wherein the projection travel (706) is less than 50% of the throat opening (490).

7. The conduit fitting splitter (100) of claim 6, wherein the projection travel (706) is at least 10% of the throat opening (490) and less than 35% of the throat opening (490).

8. The conduit fitting splitter (100) of claim 1, wherein the projection offset (704) is no more than two times the projection cross-sectional distance (702).

9. The conduit fitting splitter (100) of claim 1, wherein the projection offset (704) is at least 5% greater than the projection cross-sectional distance (702).

10. The conduit fitting splitter (100) of claim 9, wherein the projection offset (704) is 7-50% greater than the projection cross-sectional distance (702).

11. The conduit fitting splitter (100) of claim 10, wherein the projection offset (704) is 9-25% greater than the projection cross-sectional distance (702).

12. The conduit fitting splitter (100) of claim 1, wherein the at least one crack propagation projection (500) of the distal jaw (300) includes at least three adjustable crack propagation projections (700) extending from a distal jaw interior surface (340) toward a proximal jaw interior surface (250), and each projection offset (704) is no more than three times the projection cross-sectional distance (702).

13. The conduit fitting splitter (100) of claim 12, wherein each projection offset (704) is no more than two times the projection cross-sectional distance (702).

14. The conduit fitting splitter (100) of claim 1, wherein the at least one crack propagation projection (500) extending from the proximal jaw (200) includes a fixed crack propagation projection (600) extending a fixed projection height (640) from a proximal jaw interior surface (250) toward a distal jaw interior surface (340), and is an edge projection (620) having a fixed projection length (650) that is at least 50% of the projection offset (704).

15. The conduit fitting splitter (100) of claim 14, wherein fixed projection length (650) that is at least 100% of the projection offset (704).

16. The conduit fitting splitter (100) of claim 1, wherein the at least one crack propagation projection (500) extending from the proximal jaw (200) includes a plurality of fixed crack propagation projections (600) extending a fixed projection height (640) from a proximal jaw interior surface (250) toward a distal jaw interior surface (340), and consist of a plurality of point projections (610), wherein the proximal jaw (200) and an opposing distal jaw (300) define a throat opening (490), and the fixed projection height (640) is at least 2.5% of the throat opening (490).

17. The conduit fitting splitter (100) of claim 16, wherein the fixed projection height (640) is less than 10% of the throat opening (490).

18. The conduit fitting splitter (100) of claim 16, wherein a fixed projection offset (614) is a distance from the center of a point projection (610) to the adjacent point projection (610), and the fixed projection offset (614) is within 25% of the projection offset (704).

19. The conduit fitting splitter (100) of claim 16, wherein the plurality of point projections (610) are offset from the at least two adjustable crack propagation projections (700).

20. The conduit fitting splitter (100) of claim 12, wherein the at least one crack propagation projection (500) extending from the proximal jaw (200) includes a fixed crack propagation projection (600) extending a fixed projection height (640) from a proximal jaw interior surface (250) toward a distal jaw interior surface (340), and is an edge projection (620) having a fixed projection length (650) that is at least as great as the distance from the center of the first adjustable crack propagation projection (700), across the second adjustable crack propagation projection (700), to the center of the third adjustable crack propagation projection (700).

21. The conduit fitting splitter (100) of claim 12, wherein the at least one crack propagation projection (500) extending from the proximal jaw (200) includes a fixed crack propagation projection (600) extending a fixed projection height (640) from a proximal jaw interior surface (250) toward a distal jaw interior surface (340), and is an edge projection (620) having a fixed projection length (650) that is at least twice the fixed projection height (640).

22. The conduit fitting splitter (100) of claim 1, further including a fitting positioner (480) attached to the conduit fitting splitter (100) and having a positioning edge (481) to engage the conduit (1100) and properly position the conduit fitting splitter (100) around the conduit fitting (900) to achieve a predetermined fracture pattern.

23. The conduit fitting splitter (100) of claim 14, wherein the fixed projection height (640) varies at two or more locations throughout the fixed projection length (650).

24. The conduit fitting splitter (100) of claim 23, wherein the fixed projection height (640) at one point along the fixed projection length (650) is at least 50% greater than the fixed projection height (640) at a second point along the fixed projection length (650).

25. The conduit fitting splitter (100) of claim 1, further including a splitter support system (110) that releasably attaches to the conduit (1100) to hold the conduit fitting splitter (100) in place when the conduit fitting (900) fractures.
